(19) United States
(12) Patent Application Publication
(10) Pub. No.: US 2010/0275725 A1
(43) Pub. Date: Nov. 4, 2010

(54) TORQUE-SPLITTING TRANSMISSION

(76) Inventors: Detlef Tolksdorf, Essen (DE); Nils Trautmann, Oer-Erkenschwick (DE)

Correspondence Address: JORDAN AND HAMBURG LLP, 122 EAST 42ND STREET, SUITE 4000, NEW YORK, NY, 10168, US

(21) Appl. No.: 12/746,652

(22) PCT Filed: Nov. 29, 2008
(86) PCT No.: PCT/DE2008/002001

§ 371 Date: Jun. 15, 2010

(30) Foreign Application Priority Data
Dec. 7, 2007 (DE) 102007059321.1

(51) Int. Cl. F16H 47/02

(52) U.S. Cl. 74/732.1

(57) ABSTRACT

The invention relates to a hydrostatic-mechanical torque-splitting transmission, comprising a housing, or a housing composed of individual housing parts, at least one drive shaft that is disposed inside the housing and can be driven by at least one driving motor, particularly an internal combustion engine, said drive shaft acting on at least two hydraulic pumps by way of gear elements in the manner of a pump transfer case and comprising at least one further gear wheel, which directly or indirectly acts on an output element of a power-shift transmission, wherein at least in the region of the gear wheel at least one coupling element is positioned, and wherein the power-shift transmission has at least one shaft that can be driven in the hydrostatic circuit, in the region of said shaft couplings, brakes, components of a single-stage planetary gear and similar components being provided, wherein the output element of the power-shift transmission is switched to at least one output shaft.

### BACKGROUND OF THE INVENTION

The invention relates to a hydrostatic mechanical torque-splitting transmission.

A hydrostatic mechanical torque-splitting transmission is described in DE 10 2004 001 929 A1 having a continuously variable gear transmission ratio. A hydrostatic gear part is composed of a first hydrostatic unit having an adjustable volume and a second hydrostatic unit having a constant volume. A mechanical gear part comprises a summing transmission and a range change gearbox, in which the summing transmission and the range change gearbox are axially offset with respect to the hydrostatic units.

Another torque-splitting transmission is described in DE 103 13 486 A1 which comprises a hydrostatic gear part and a mechanical gear part, wherein the powers of the gear parts are brought together in a summing transmission. The summing transmission includes an input shaft, an output shaft and an intermediate shaft on which the motor and the pump of the hydrostatic gear part are placed. The output of the hydrostatic gear part is connected to the summing transmission by means of a gear wheel. A hydraulically operable axial claw clutch is arranged on the output side of the hydrostatic gear part in flux direction after the motor, which axial claw clutch detachably connects the driving gear wheel to the output of the hydrostatic gear part by means of an axial claw.

DE 44 04 829 C2 discloses a hydrostatic mechanical power-shift transmission, in particular for mobile construction and working machines, which comprises at least two hydraulic motors that can be driven by at least one pump and that are actively related to at least one pair of gear wheels on the side of the input shaft. The hydraulic motors are connected to each other via a clutch for adding the engine torques of both hydraulic motors in a first speed range of the construction and working machine. At least one planet gear is included, having at least one output shaft of the power-shifting transmission. The gear ring of said planet gear may be susceptible to be fixed via at least one brake, wherein in another speed range following the first speed range at least one of the hydraulic motors can be disengaged via the clutch of the drive shaft of the other hydraulic motor. The hydraulic motor which can be disengaged by the drive shaft can be non-positively coupled on the gear ring of the planet gear according to the principle of superposition by means of another clutch provided in the region of its drive shaft for mechanically adding the engine torques of both hydraulic motors.

It is an object of the subject invention to provide an alternative hydrostatic mechanical torque-splitting transmission which has a simple structure and permits different shifting states.

### SUMMARY OF THE INVENTION

The present invention provides a hydrostatic mechanical torque-splitting transmission that may be driven by a motor and act upon an output shaft. The transmission includes a drive shaft, located at least partially within a housing, for being driven by the motor. Also included are a plurality of hydraulic pumps, a power shift transmission and various gear mechanisms. One gear mechanism couples the drive shaft to one or more of the hydraulic pumps. Another gear mechanism couples the drive shaft to an output element of the power shift transmission. Still another gear mechanism couples the output element to the output shaft. A clutch also is included, which clutch defines an operating state of the torque-splitting transmission in which the drive shaft is decoupled from the hydraulic pumps.

In various embodiments of the invention, one or more clutch mechanisms may be implemented to select optional operating states of the torque-splitting transmission, including a purely hydraulic state, a purely mechanical state, and a torque-splitting hydraulic and mechanical state.

In some embodiments of the invention a single common housing serves as the enclosure for pump transfer case structures and the power shift transmission. Such a housing allows for a smaller construction space in mobile vehicles, such as construction machines and the like. Such a housing also enables the various operating states to be realized in a simple manner.

### BRIEF DESCRIPTION OF THE DRAWINGS

FIG. 1 is a schematic view of the hydraulic mechanical power shift transmission operating in a mechanical power state with only mechanical power flow, according to an embodiment of the present invention;

FIG. 2 is a schematic view of the hydraulic mechanical power shift transmission operating in a hydraulic power state with only hydraulic power flow, according to an embodiment of the present invention; and

FIG. 3 is a schematic view of the hydraulic mechanical power shift transmission operating in a torque splitting state with both mechanical and hydraulic power flow, according to an embodiment of the present invention.

### DETAILED DESCRIPTION OF THE INVENTION

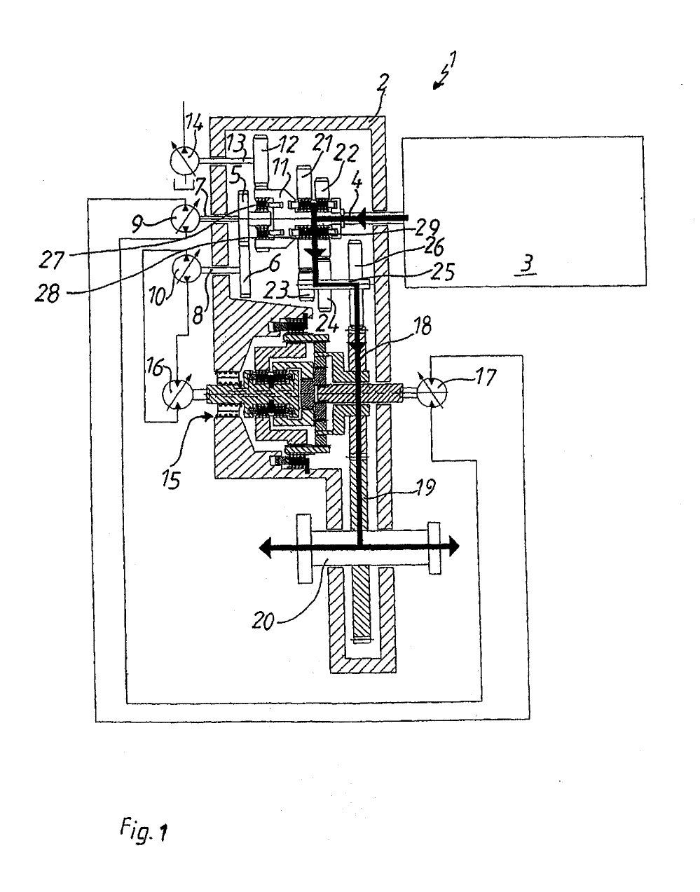

FIGS. 1 through 3 show schematic diagrams of different operating states of the torque-splitting transmission 1. The torque-splitting transmission 1 comprises a housing 2 made of cast material, which comprises a drive shaft 4 that can be driven by a diesel engine 3. A gear element 5 is directly fixed on the drive shaft 4, which gear element meshes with another gear element 6. The gear elements 5, 6 respectively act on a hydraulic pump 9, 10 via shafts 7, 8. Axially in front of said gear element 5 a gear ring 11 is placed which meshes with another gear element 12 which is connected to another hydraulic pump 14 via a shaft 13. Usually said gear elements 5, 6, 12 are arranged inside a common pump transfer case and are driven by the drive shaft 4 while acting on the hydraulic pumps 9, 10, inside the same housing 2. Such power-shift transmissions are for example 14. This basic principle is extended in such a way that a power-shift transmission 15 is also placed described in DE 44 04 829 C2 such that the constructional structure will not be explained in detail here, but with regard to the individual components it is rather made reference to this publication. In analogy to this publication, engine torques in a first speed range of for example a construction machine and speeds in another speed range can be added also here. The hydraulic pumps 9, 10 cooperate in a closed circuit with hydraulic motors 16, 17 provided in the region of the power-shift transmission 15. On the output side, the power-shift transmission 15 comprises an output element 18 which is actively related to an output shaft 20 via a gear wheel 19. The torque-splitting transmission 1 according to the invention can be for example mounted in a wheel loader. For realizing different shifting states of the torque-splitting transmission 1 two gear wheels 21, 22 having different diameters are arranged on the drive shaft 4 in this example, which gear wheels mesh with other gear wheels 23, 24 that also have different diameters. Said gear wheels 23, 24 are actively related to another gear wheel 26 via a shaft section 25, which gear wheel 26 meshes in turn with the output element 18.

Both the gear ring 11 and the gear wheels 21, 22 are equipped with clutch elements 27, 28, 29.

In FIG. 1 one can see a defined power flow (arrow) in which the diesel engine 3 drives the gear stage 21, 23 or 22, 24, the shaft section 25, the gear wheel 26, the output element 18, the gear wheel 19 and the output shaft 20 via the drive shaft 4. A purely mechanical power flow is given here without the hydraulic pumps 9, 10 being active. This does not concern the hydraulic pump 14 which can be, if required, a working pump and therefore has to be always in operation. This means that the clutch 27 is opened and the hydraulic pumps 9, 10 are not provided with power. The hydraulic pump 14 is driven by means of the gear ring 11, the gear wheel 12 as well as the shaft 13.

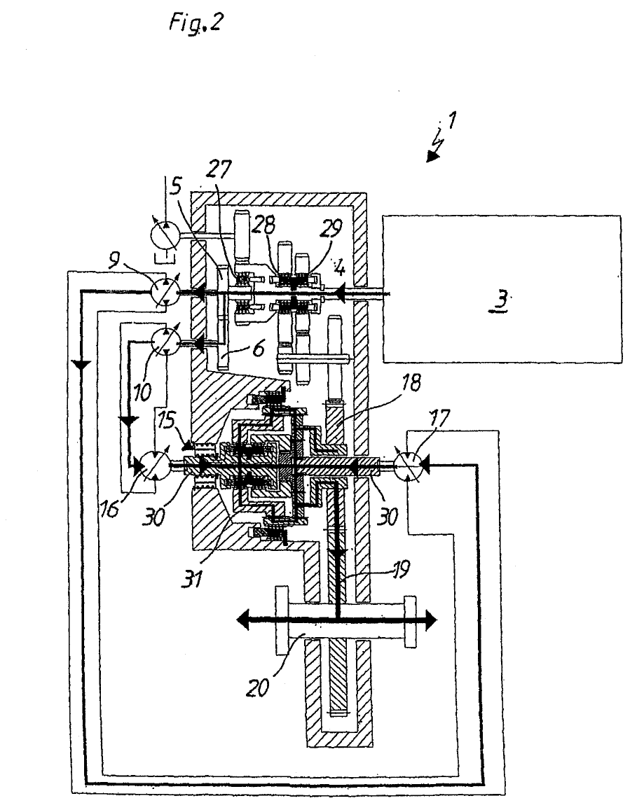

FIG. 2 shows a different operating state. The power flow (arrow) is also represented here. The diesel engine 3 drives the drive shaft 4, wherein the clutches 28, 29 are open and thus no direct power transmission to the output element 18 can be realized. The clutch 27 is closed such that the hydraulic pumps 9, 10 are driven by means of the gear elements 5, 6. In the closed hydrostatic circuit the hydraulic motors 16, 17 are now also pressurized via the hydraulic pumps 9, 10, such that the planet gear 31 of the power-shift transmission 15 is activated by means of the common drive element 30. The gear wheel 19 and thus the output shaft 20 are driven by the output element 18. This shifting state is a purely hydraulic operating state.

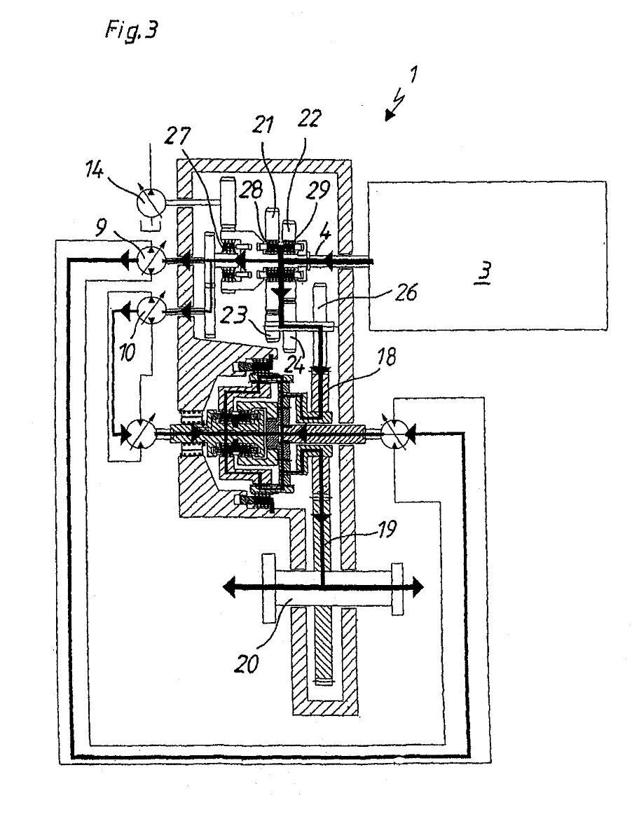

FIG. 3 now shows the hydraulic and mechanical torque-splitting operation mode of the torque-splitting transmission 1 according to the invention (arrow). Depending on the shifting state, either the clutch 28 or the clutch 29 is closed, such that either the gear stage 21, 23 or the gear stage 22, 24, the shaft section 25, the gear wheel 28 can act on the output element 18. Simultaneously, the clutch 27 is closed such that the diesel engine 3 also drives the hydraulic pumps 9, 10 via the drive shaft 4. The further shifting principle has already been mentioned in FIG. 2. The common power will be shifted via the output element 18 onto the output shaft 20 provided with the gear wheel 19. In analogy to FIGS. 1 and 2, also here the hydraulic pump 14 is always driven.

1.-9. (canceled)

10. A hydrostatic mechanical torque-splitting transmission for being driven by a motor and for acting upon an output shaft, comprising:
a housing
a drive shaft, located at least partially within the housing, for being driven by the motor;
a first hydraulic pump;
a second hydraulic pump;
a power shift transmission having an output element;
first gear means for coupling the drive shaft to the first hydraulic pump and the second hydraulic pump;
second gear means for coupling the drive shaft to the output element;
third gear means for coupling the output element to the output shaft; and
clutch means for defining an operating state in which the drive shaft is decoupled from the first gear means.

11. The torque-splitting transmission of claim 10, further comprising a third hydraulic pump and a fourth gear means within the pump transfer case for coupling the drive shaft to the third hydraulic pump.

12. The torque-splitting transmission of claim 10, in which the clutch means is a first clutch means and further comprising a second clutch means for defining an operating state in which the drive shaft is decoupled from the output element of the power shift transmission.

13. The torque-splitting transmission of claim 12, in which the second gear means comprises at a first gear wheel for engaging the drive shaft and a second gear wheel for engaging the drive shaft, and wherein the second clutch means comprises a first clutch for decoupling the first gear wheel from the drive shaft and a second clutch for decoupling the second gear wheel from the drive shaft.

14. The torque-splitting transmission of claim 10, wherein the second gear means comprises a first stage of one or more gears, a second stage of one or more gears, and a third gear body which couples the second stage to the output element.

15. The torque-splitting transmission of claim 11, wherein the fourth gear means comprises a gear ring on the drive shaft and a gear for engaging the gear ring.

16. The torque-splitting transmission of claim 15, in which the clutch is a first clutch, further comprising a third clutch for defining an operating state in which drive shaft is decoupled from the fourth gear means, and wherein the gear ring receives the first clutch and the third clutch.

17. The torque-splitting transmission of claim 10, in which the clutch is formed as a multi-disk clutch.

18. The torque-splitting transmission of claim 10, in which the housing is a common housing for the first, second, third and fourth gear means and the power-shift transmission.
